(19) United States
(12) Patent Application Publication
(10) Pub. No.: US 2012/0311879 A1
(43) Pub. Date: Dec. 13, 2012

(54) MESMETRU

(76) Inventor: Nicolae Mesesan, Oradea (RO)

(21) Appl. No.: 13/579,096

(22) PCT Filed: Jan. 17, 2011
(86) PCT No.: PCT/RO2011/000002

§ 371 Date: Aug. 15, 2012

(30) Foreign Application Priority Data
Feb. 15, 2010 (RO) A 2010 00135

(51) Int. Cl. B43L 7/10

(52) U.S. Cl. 33/415

(57) ABSTRACT

This invention called MesMetru pertains to the field of forensic technique of measuring incriminating objects and evidence and consists of three groups of identical blades, printed with metric measurement units, joined together in the 0 common point of each unit, forming a unitary measurement unit that can help us make the measurement of the three sides of any object: length, width and height through a single use of the measurement unit and take a single photograph that highlights the sizes of the three sides.

This invention pertains to the technical field of measurement units in general and particularly to the field of techniques for crime scene investigations carried out by the police and the prosecutor's office (in murder cases, traffic accidents, catastrophes, work accidents etc.). According to the legislation in force, the forensic technician working at the crime scene must identify incriminating evidence and objects related to the case and take metric photographs, being allowed to collect the respective objects only after photographing them (a metric photograph is the picture taken of the incriminating object next to which they place, in parallel, a unit of measurement). Currently, the measurements of incriminating objects and evidence found at the crime scene are done with tailor rulers, measuring tape, rulers etc. and these measuring tools now have various shapes and colors, both for the background and the size of the printed numbers. Due to the colors, sizes and manufacturing materials, these measurement units are not clearly visible in the pictures. Currently, the photographing of incriminating bodies or evidence requires the taking of three metric photographs: one for the length, one for the width and one for the height. This invention solves all these problems with the help of MesMetru, made of steel blades that are approximately 15-centimeter long, 2-centimeter wide and 1-centimeter thick, printed with the units of measurement of meter and millimeter, riveted together to allow folding, the number of blades can vary depending on the length of the ruler we want. The MesMetru is made up of three groups of blades fastened together in point 0, so that each group of blades swivels and measures the length, width and thickness in one move, so that a single metric photograph can be taken with all three dimensions of the object, the color of the blades shall be yellow and the numbers shall be black and large.

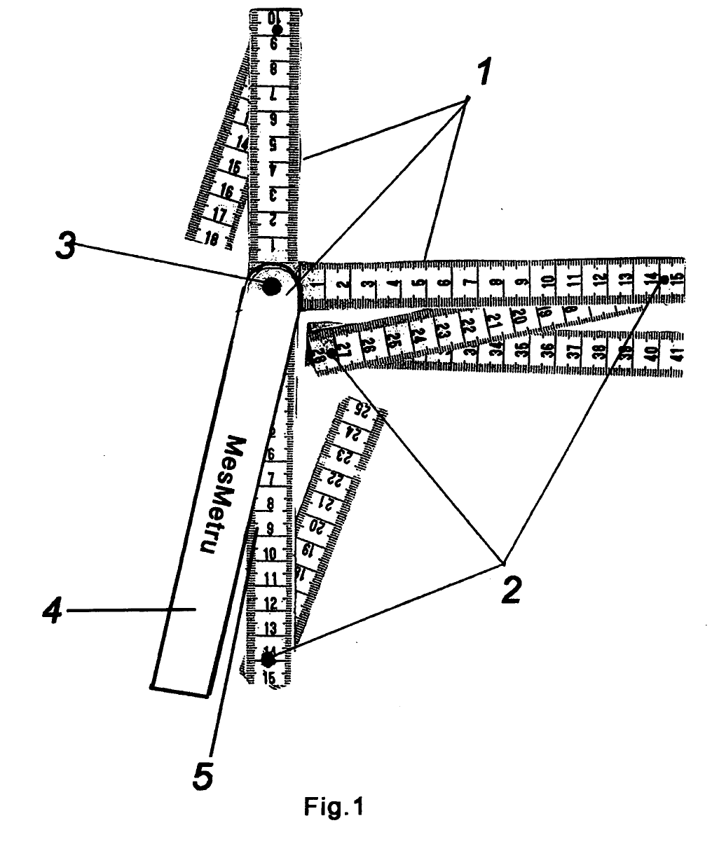

The MesMetru (FIG. 1) described in this invention consists of steel blades, resistant to handling (1) fastened together with rivets so they can swivel (2), the three groups of blades are riveted together (3) and can swivel independently from each other. In order to make it easy to carry, both in a pocket and in the forensic kit, it comes with a holder where all blades can be folded in (4) and this holder also acts as a handle during the use of the ruler. The blades that measure height are flexible and foldable so that they can rise up (5) to measure the height.

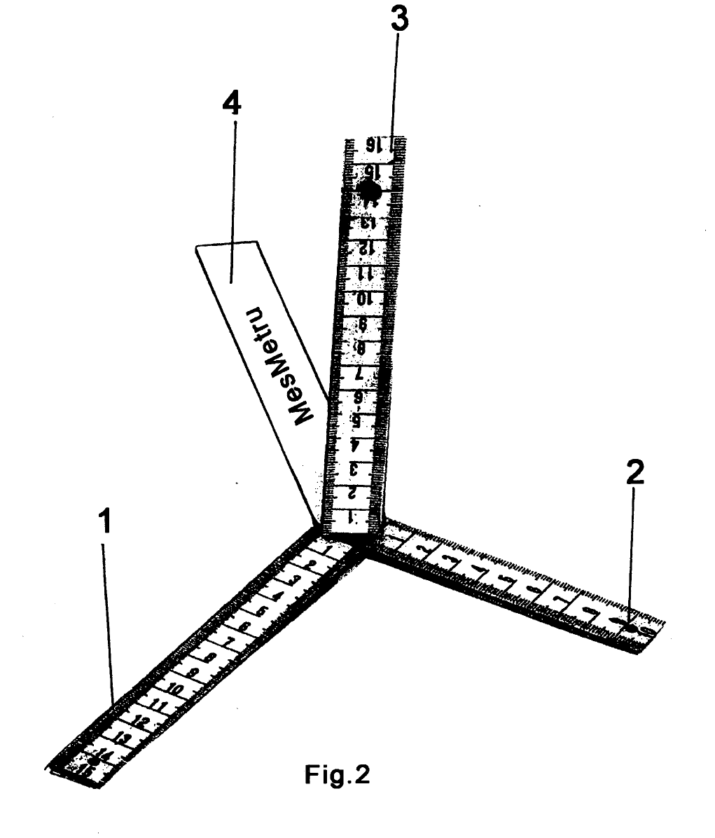

The working position of the MesMetru is presented in FIG. 2 where it measures (1) length, (2) width, (3) height and (4) is the handle and the casing.

This invention can be manufactured at industrial scale and can also be used in other fields of activity.

In total, the MesMetru is approximately 20-centimeter long, 2-centimeter wide and 1-centimeter thick.

These are the advantages of the MesMetru:
the sides of the objects can be measured instantly, in one operation;
each side can also be measured individually;
the ruler has a very good visibility in the picture;
the size reading is accurate due to the common point 0 where the measurement starts;
it is resistant to mechanical shocks and weather-proof;
takes up little space in the forensic kit, it is light and can also be carried in the pocket;
replaces all units of measurement that have been used to date for crime scene investigations;
can also be used in other fields of activity and can also have industrial applications.

1. Unlike other units of measurement, the foldable MesMetru can make accurate measurements of objects: lengths, widths and heights, through a single operation and placing them in a single picture.

2. It is made of swiveling steel blades that can form the desired lengths, depending on the number of segments added on and the three groups of blades form a compact, foldable, easy-to-use unit to measure the three sides; the yellow color of the background and the black color of the numbers are distinctive and easy to view, while the handle is also the casing of this MesMetru.
